(19) United States
(12) Patent Application Publication
(10) Pub. No.: US 2012/0330662 A1
(43) Pub. Date: Dec. 27, 2012

(54) INPUT SUPPORTING SYSTEM, METHOD AND PROGRAM

(75) Inventor: Masahiro Saikou, Tokyo (JP)

(73) Assignee: NEC CORPORATION, Tokyo (JP)

(21) Appl. No.: 13/575,898

(22) PCT Filed: Jan. 17, 2011
(86) PCT No.: PCT/JP2011/000201

§ 371 Date: Jul. 27, 2012

(30) Foreign Application Priority Data
Jan. 29, 2010 (JP) 2010-018848

(51) Int. Cl. G10L 15/00

(52) U.S. Cl. 704/239; 704/E15.001

(57) ABSTRACT

An input supporting system (1) includes a database (10) which accumulates data for a plurality of items therein, an extraction unit (104) which compares, with the data for the items in the database (10), input data which is obtained as a result of a speech recognition process on speech data (D0), and extracts data similar to the input data from the database, and a presentation unit (106) which presents the extracted data as candidates to be registered in the database (10).

### TECHNICAL FIELD

The present invention relates to an input supporting system, method and program, and particularly to an input supporting system, method and program for supporting data input by use of speech recognition.

### BACKGROUND ART

There is described in Patent Document 1 (Japanese Laid-Open patent publication NO. 2005-284607) an exemplary business supporting system which supports processings of information obtained by business activities by way of this type of data input by using speech recognition. The business supporting system in Patent Document 1 is configured of: a business support server which is connectable to a client terminal with a call function and a communication function via the Internet network, including a database which stores business information files for business activities in a document form and a search processing unit which performs a processing of searching a specific business information file in the database; and a speech recognition server which is connectable to the client terminal via a telephone network and has a speech recognition function of recognizing speech data and converting it into document data.

With the structure, a user such as salesman can make a business report in a telephone conversation form into text and register it in a business supporting system. In case where it is inconvenient to input character, input items which have a large amount of characters to be typed can be finally stored in the server as character data by changing the business supporting system to the speech recognition system.

### RELATED DOCUMENT

### Patent Document

[Patent Document 1] Japanese Laid-Open patent publication NO. 2005-284607

### SUMMARY OF THE INVENTION

In the above-described business supporting system, recognition error in the speech recognition is inevitable and uttered speeches include slips or surplusages such as “um”, and thus there is a problem that even when the speech recognition process can be performed without an error, the recognition result itself is difficult to employ as input data.

It is an object of the present invention to provide an input supporting system, method and program for properly, precisely and efficiently performing data input by speech recognition as the above problem.

An input supporting system according to the present invention includes:

a database which accumulates data for a plurality of items therein;

an extraction unit which compares, with the data accumulated in the database, input data which is obtained as a result of a speech recognition process on speech data and extracts data similar to the input data from the database; and

a presentation unit which presents the extracted data as candidates to be registered in the database.

A data processing method in an input supporting apparatus according to the present invention is a data processing method in an input supporting apparatus including a database which accumulates data for a plurality of items therein, including:

Comparing, with the data accumulated in the database, input data which is obtained as a result of a speech recognition process on speech data, and extracting data similar to the input data from the database; and

presenting the extracted data as candidates to be registered in the database.

A computer program according to the present invention causes a computer implementing an input supporting apparatus including a database which accumulates data for a plurality of items therein to execute:

a procedure of comparing, with the data accumulated in the database, input data which is obtained as a result of a speech recognition process on speech data, and extracting data similar to the input data from the database; and

a procedure of presenting the extracted data as candidates to be registered in the database.

It is to be noted that one obtained by converting an arbitrary combination of the above constitutional elements or the expression of the invention between methods, apparatuses, systems, record mediums, computer programs or the like is also effective as an aspect of the invention.

Further, a variety of constitutional elements of the invention are not necessarily individually independent existence, but may be formed such that a plurality of constitutional elements are formed as one member, one constitutional element is formed as a plurality of members, one constitutional element is part of another constitutional element, or part of one constitutional element overlaps with part of another constitutional element.

Moreover, although a plurality of procedures are sequentially described in the data processing method and the computer program of the invention, the described sequence does not limit a sequence of execution of the plurality of procedures. On this account, in carrying out the data processing method and the computer program of the invention, the sequence of the plurality of procedures may be changed within a range not interfering with the procedures in terms of details thereof.

Furthermore, the plurality of procedures in the data processing method and the computer program of the invention are not limited to execution with individually different timing. Therefore, the procedures maybe executed such that another procedure occurs during execution of one procedure, or execution timing for one procedure overlaps with part or all of execution timing for another procedure.

According to the invention, there are provided an input supporting system, method and program for properly, precisely and efficiently performing data input by speech recognition.

### BRIEF DESCRIPTION OF THE DRAWINGS

The foregoing object, other objects, characteristics and advantages will further be made obvious by means of exemplary embodiments that will be described hereinafter and the following drawings associated with the exemplary embodiments.

FIG. 1 is a functional block diagram showing a structure of an input supporting system according to an exemplary embodiment of the present invention.

FIG. 2 is a diagram showing an exemplary structure of a database in the input supporting system according to the exemplary embodiment of the present invention.

FIG. 3 is a flowchart showing exemplary operations of the input supporting system according to the exemplary embodiment of the present invention.

FIG. 4 is a diagram for explaining operations of the input supporting system according to the exemplary embodiment of the present invention.

FIG. 5 is a functional block diagram showing a structure of an input supporting system according to an exemplary embodiment of the present invention.

FIG. 6 is a block diagram showing a structure of main part of the input supporting system according to the exemplary embodiment of the present invention.

FIG. 7 is a diagram showing an exemplary screen to be presented on a presentation unit in the input supporting system according to the exemplary embodiment of the present invention.

FIG. 8 is a flowchart showing exemplary operations of the input supporting system according to the exemplary embodiment of the present invention.

### DESCRIPTION OF EXEMPLARY EMBODIMENTS

Hereinafter, exemplary embodiments of the invention will be described using the drawings. It is to be noted that in all of the drawings, similar constitutional elements will be provided with similar reference numerals, and descriptions thereof will not be repeated as appropriate.

### First Exemplary Embodiment

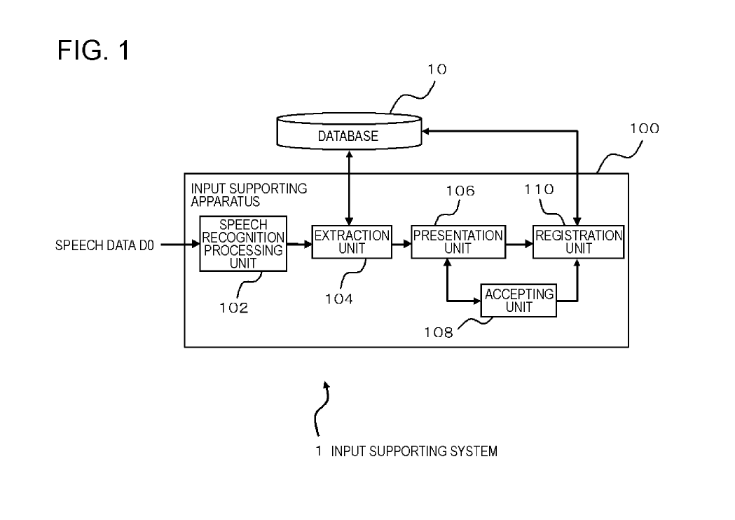

FIG. 1 is a functional block diagram showing a structure of an input supporting system 1 according to an exemplary embodiment of the present invention.

As illustrated, the input supporting system 1 according to the present exemplary embodiment includes a database 10 which accumulates data on a plurality of items therein, an extraction unit 104 which compares, with the data accumulated in the database 10, input data which is obtained as a result of a speech recognition process on speech data D0 and extracts data similar to the input data from the database 10, and a presentation unit 106 which presents the extracted data as candidates to be registered in the database. The input supporting system 1 according to the present exemplary embodiment further includes an accepting unit 108 which accepts selections of the data to be registered for the respective items from among the candidates presented by the presentation unit 106, and a registration unit 110 which registers pieces of the accepted data in the respectively corresponding items in the database 10.

Specifically, the input supporting system 1 includes the database 10 which accumulates pieces of data for a plurality of items therein, and an input supporting apparatus 100 which supports data input into the database 10. The input supporting apparatus 100 includes a speech recognition processing unit 102, the extraction unit 104, the presentation unit 106, the accepting unit 108 and the registration unit 110.

Herein, the input supporting apparatus 100 may be realized by a server computer or personal computer or an equivalent device, not illustrated, including a Central Processing Unit (CPU) or memory, a hard disk and a communication device, for example, and which is connectable to an input device such as keyboard or mouse or an output device such as display or printer. Then, the CPU reads a program stored in the hard disk onto the memory and executes the program, thereby realizing each function of each unit.

Note that the drawings referred to hereinbelow do not show configurations of portions irrelevant to the essence of the present invention.

Each constituent in the input supporting system 1 may be implemented by an arbitrary combination of hardware and software of an arbitrary computer mainly contributed by a CPU, a memory, a program loaded on the memory so as to implement the constituent illustrated in the drawing, a storage unit such as hard disk which stores the program, and an interface for network connection. Those skilled in the art may understand various modifications derived from the methods of implementation and relevant devices. The drawings explained below illustrate function-based blocks, rather than hardware-based configuration.

In this exemplary embodiment, for example, it is assumed that in a business supporting system for supporting business activities, there are prepared a large number of various input items for business tasks information such as client corporate information, business meeting progress and business daily report. The business tasks information is accumulated in the database 10 of the input supporting system 1, and is variously utilized for analysis of business performance, analysis of client and company, performance evaluation of salesman, future business activity plan, management strategy and the like.

The database 10 may include client information on clients, such as client attribute, client's opinion, competition information, contact history with client, and the like. The client attribute may include client's basic information (such as company name, address, phone number, number of employees and business type name) or client's credit information, and the like. The client's opinion may include strategy, needs, requests, opinions, complaints and the like, and may include, for example, information indicating “clients desire a solution for ‘globalization’ and ‘response to environment’”.

The competition information may include information on competitive business partners, and transaction amount and period with them. The contact history with client may include information on “when, who, to whom, where, what, how reaction and result?”

Further, the database 10 may include information on business meetings (cases) and information on business person activities. For example, the information on business meetings (cases) may include information on the number of business meetings per client and a period for each business meeting, such as estimated quantity, the number of business meetings (cases) and a business period, information on a current progress phase and a probability of order receipt, such as progress state (first visit→hearing→proposal→estimation→request for approval→order reception) and accuracy of order reception for case, and information on budget state, person with authority for business and decision timing, such as budget, person with authority, needs and timing.

The sales person activity information may include information on grasp of person in charge/number of business matters, and activity (visit) plan, such as PLAN (plan)-DO (do) in PDCA cycle (Plan-Do-Check-Act cycle), information on check as to whether the client information has been checked, such as collection of information, information on input specific next action, such as next action and expiration, and information on total steps (time) spent so far, or how to use a time, such as activity amount and activity trend.

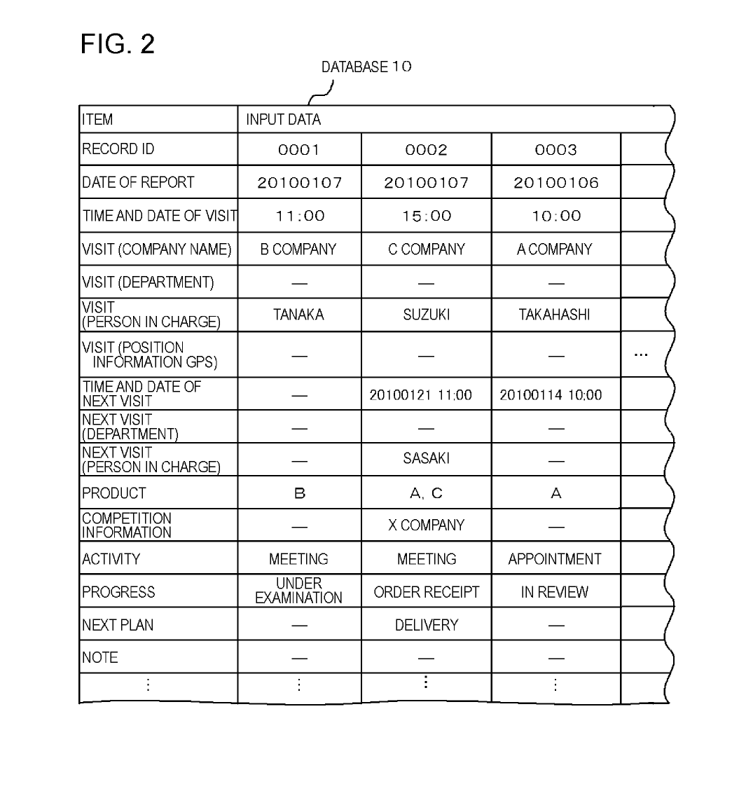

FIG. 2 shows an exemplary structure of the database 10 in the input supporting system 1 according to the present exemplary embodiment. A business supporting system will be described in this exemplary embodiment as an example. FIG. 2 shows, for example, a group of data items such as daily report data in the accumulated data in the database 10 for simplified description, but the structure of the database 10 is not limited thereto, and it is assumed that various items of information are associated with each other and accumulated as described above. For example, the information on client's company name, department and person in charge in the data items of FIG. 2 is part of the client information and may be associated with the client information.

Turning to FIG. 1, the speech recognition processing unit 102 inputs speech data D0 generated based on obtained speech uttered by the user, performs a speech recognition process, and outputs the result as input data, for example. The speech recognition result includes the speech characteristic amount, a phoneme, a syllabic sound and a word of the speech data, for example.

For example, after being at a client company, the user may make a call from a portable terminal (not shown) such as cell phone to a server (not shown), make a business report via speech, and record speech data in the server. Alternatively, the user's uttered speech is recorded by a recording device (not shown) such as IC recorder and then the speech data may be uploaded from the recording device to the server. Alternatively, a microphone (not shown) is provided on a personal computer (PC) (not shown) to record user's uttered speech via the microphone and the speech data may be uploaded from the PC to the server via a network. Units and methods for obtaining the user-uttered speech data may be implemented in various ways but are not essential for the present invention, and thus a detailed explanation thereof will not be repeated.

As described above, when a cell phone or the like is used as a user terminal (not shown) when the user is out, a Global Positioning System (GPS) function may be used to obtain position information on where the user is out, a photographing function of a camera may be used to obtain photographed image data, an IC recorder function maybe used to record speech data, and these information may be transmitted to and accumulated in the server of the input supporting system 1 by use of a wireless communication function via a network.

The server according to the present exemplary embodiment is a Web server, for example, and the user uses a browser function of the user terminal to access a predetermined URL address and to upload information including the speech data, thereby transmitting the information to the server. As needed, the server may be provided with a user recognition function which makes user be possible to log in the server by the user authentication and to then access the server.

The input supporting system 1 according to the present invention may be provided to the user as Software As A Service (SaaS) type service.

Alternatively, there may be configured such that an e-mail attached with an information file including the speech data is transmitted to a predetermined e-mail address thereby to transmit the information to the server. As described above, the speech data D0 is input into the input supporting system 1 to be subjected to the speech recognition process by the speech recognition processing unit 102, and is made into text data to be output as input data to the extraction unit 104.

The extraction unit 104 compares the input data obtained from the speech recognition processing unit 102 with the data accumulated in the database 10, and extracts data similar to the input data from the database 10. Herein, the recognition result by the speech recognition processing unit 102 may be stored in a storage unit (not shown), and maybe read by the extraction unit 104 and processed as needed. Methods for matching the speech recognition result with the data in the database 10 may be implemented in various ways but are not essential for the present invention, and a detailed explanation thereof will not be repeated.

The present exemplary embodiment is configured such that the extraction unit 104 extracts data “similar” to the speech recognition result from the database 10, but only data perfectly matching with the speech recognition result may be also extracted. Alternatively, the extraction unit 104 may change a similarity according to a degree of probability of the speech recognition result, or may extract data having a predetermined similarity or more.

Since the extraction unit 104 extracts data from the data previously registered in the database 10 in this exemplary embodiment, and a redundant expression such as “um” is not present in the database 10 and cannot be extracted as a candidate. Since even when the speech recognition processing unit 102 makes an error of recognition, the extraction unit 104 extracts similar data present in the database 10, the extracted data can be confirmed and correct data can be selected.

When the redundant expression such as “um” is included in the result obtained from the speech recognition processing unit 102, it is preferable that the processing of extracting such these expressions are not performed in the extraction processing by the extraction unit 104. For example, these redundant expressions are previously registered as those to be excluded in the database 10 or in the storage unit (not shown) in the input supporting apparatus 100. When a recognition result on a redundant expression is obtained by the speech recognition processing unit 102, the extraction unit 104 may refer to the storage unit and confirm whether the expression is a surplusage to be excluded, and may perform a processing of excluding the redundant expression from the recognition result.

For example, the presentation unit 106 displays the data extracted by the extraction unit 104 as candidates to be registered in the database 10 on a screen of a display unit (not shown) provided in the input supporting apparatus 100, and presents it to the user. Alternatively, the presentation unit 106 may display the screen on a display unit (not shown) on another user terminal which is different from the input supporting apparatus 100 and is connected to the input supporting apparatus 100 through a network.

For example, the presentation unit 106 presents, to the user, the candidates via a user interface such as a pull-down list, a radio button or check box, or a free text input column, and causes the user to select from among the presented candidates.

The accepting unit 108 causes the user to utilize an operation unit (not shown) provided in the input supporting apparatus 100 and to select data to be registered for each item from the candidates presented by the presentation unit 106, and accept the selected data in association with the respective items. As described above, it may accept an operation when the user uses an operation unit (not shown) of another user terminal which is different from the input supporting apparatus 100 and is connected to the input supporting apparatus 100 through a network. The user may re-select data via a pull-down menu or check box, and may correct and add the contents of the text box as needed while confirming the contents presented by the presentation unit 106. The accepting unit 108 may accept the data selected or input by the user.

The registration unit 110 registers the data accepted by the accepting unit 108 as new records of the database 10 in the corresponding items, respectively.

A computer program according to the present exemplary embodiment is described to cause the computer implementing the input supporting apparatus 100 provided with the database 10 accumulating the data for the items therein to execute a procedure of comparing, with the data accumulated in the database 10, which the input data is obtained as a result of the speech recognition process on the speech data D0 and extracting data similar to the input data from the database 10, and a procedure of presenting the extracted data as candidates to be registered in the database 10.

The computer program of this exemplary embodiment may be stored in a computer-readable storage medium. The storage medium is not specifically limited, and allows various forms. The program may be loaded from the storage medium into a memory of a computer, or may be downloaded through a network into the computer, and then loaded into the memory.

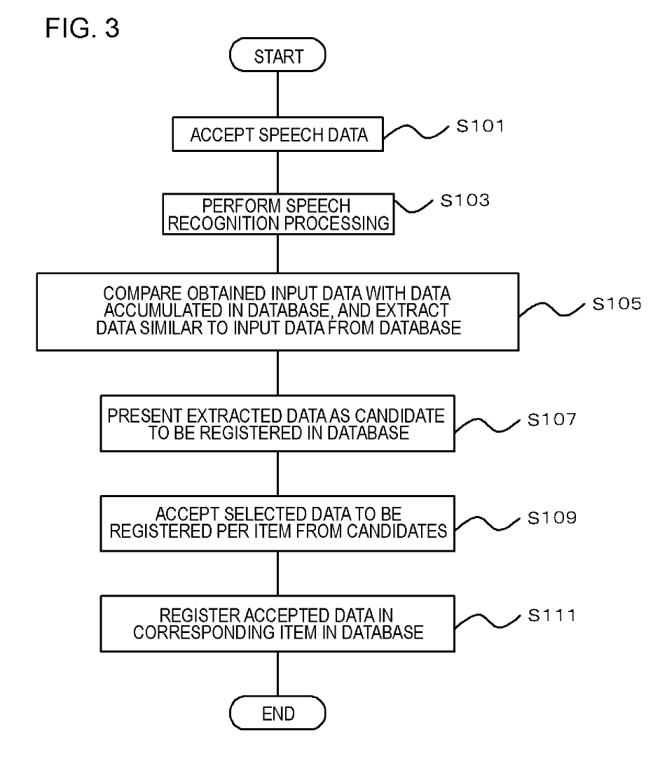

With the above structure, a data processing method by the input supporting apparatus 100 in the input supporting system 1 according to the present exemplary embodiment will be described below. FIG. 3 is a flowchart showing exemplary operations of the input supporting system 1 according to the present exemplary embodiment.

The data processing method by the input supporting apparatus according to the present invention is a data processing method by an input supporting apparatus provided with the database 10 accumulating data for a plurality of items therein, the method comparing, with the data accumulated in the database 10, the input data which is obtained as a result of the speech recognition process on the speech data D0, extracting data similar to the input data from the database 10, and presenting the extracted data as candidates to be registered in the database 10.

The operations of the input supporting system 1 according to the present exemplary embodiment having the above structure will be described below.

An explanation will be made below with reference to FIGS. 1 to 4.

At first, the user makes an activity report via speech, and records its speech data in order to create a report of the business activity. As described above, various speech data recording methods may be employed, and for example, it is assumed herein that speech data is recorded by an IC recorder (not shown) and the speech data uploaded on the input supporting apparatus 100 in FIG. 1 is accepted by the speech recognition processing unit 102 in the input supporting apparatus 100 (step S101 in FIG. 3). The speech recognition processing unit 102 performs a speech recognition process on the input speech data D0 (step S103 in FIG. 3) and passes its result as input data to the extraction unit 104.

The extraction unit 104 compares the input data obtained from the speech recognition processing unit 102 with the data accumulated in the database 10, and extracts data similar to the input data from the database 10 (step S105 in FIG. 3). Then, the presentation unit 106 displays the data extracted in step S105 in FIG. 3 as candidates to be registered in the database 10 on the display unit, and presents it to the user (step S107 in FIG. 3). Then, when the user selects data to be registered per item from among the candidates, the accepting unit 108 accepts selections of the data to be registered for respective items from the candidates (step S109 in FIG. 3). Then, the registration unit 110 registers pieces of the accepted data as a new record in the respectively corresponding items in the database 10 (step S111 in FIG. 3).

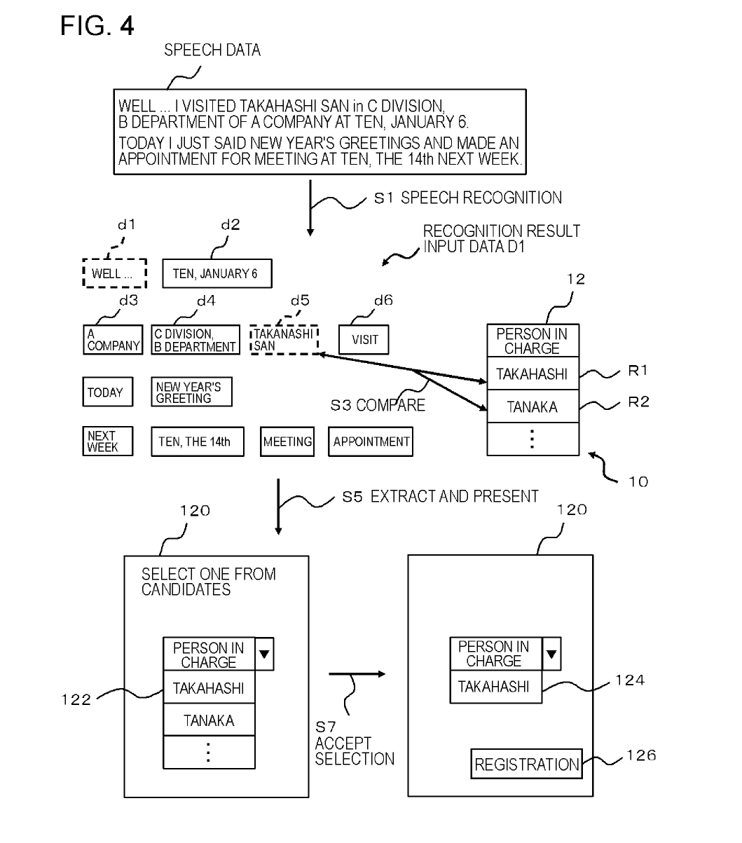

More specifically, for example, as shown in FIG. 4, when the user has made a speech such as the speech data D0, the speech recognition processing unit 102 (FIG. 1) performs the speech recognition process on the speech data D0 (step S1 in FIG. 4), and a plurality of data d1, d2, . . . , per word are obtained as the recognition result input data D1. The data is separated per word in FIG. 4, but the data is not limited thereto and may be separated per segment or sentence. Only partial data is shown in FIG. 4 for simplified description.

Each item of data in the recognition result input data D1 in FIG. 4 is compared with the data in the database 10 (step S3 in FIG. 4). Herein, for example, it is assumed that “Takahashi-san” is erroneously recognized as “Takanashi-san” in the data d5 in the recognition result input data D1 and the data on “Takanashi-san” is not present in the database 10. The extraction unit 104 (FIG. 1) extracts, as data similar to “Takanashi-san”, data including two items of data “Takahashi” and “Tanaka” corresponding to records R1 and R2 from the item 12 for person in charge. “Well . . . ” in the data d1 in the recognition result input data D1 in FIG. 4 is a surplusage and its corresponding data is not present based on the comparison with the database 10, and thus similar data is not extracted.

Then, the presentation unit 106 (FIG. 1) displays the extracted data as candidates to be registered in the database 10 on the display unit (not shown) and presents it to the user (step S5 in FIG. 4). For example, like the screen 120 in FIG. 4, a candidate list 122 including the two items of data “Takahashi” and “Tanaka” extracted by the extraction unit 104 (FIG. 1) is presented by the presentation unit 106.

For example, such a candidate list 122 is provided per item 12, the data extracted by the presentation unit 106 is displayed as the candidate list 122, and data to be registered may be selected by the user per item 12.

If data corresponding to the recognition result input data D1 is not present in the database 10, when similar data is extracted from the database 10 by the extraction unit 104, the extracted data is employed as input data's candidates instead of the data of the recognition result input data D1.

As in the example, when data perfectly matching with the recognition result “Takanashi” is not present, the recognition result “Takanashi” may be additionally presented to the user together with the extracted similar data for confirmation.

For example, FIG. 4 shows an exemplary screen 120 when data on person in charge is selected from among the item 12 in the database 10. When “Takahashi” is selected by the user from the candidate list 122 in the screen 120 of FIG. 4 (124 in FIG. 4), the accepting unit 108 (FIG. 1) accepts “Takahashi” as data to be registered in the person in charge in the database 10 (step S7 in FIG. 4). When a registration button 126 in the screen 120 in FIG. 4 is operated by the user, the registration unit 110 (FIG. 1) registers the accepted data as data on “person in charge” in the item 12 in the database 10 among the data included in the new daily report records. Further, data on other item 12 included in the new daily report records is also registered per item 12.

In this way, with the input supporting system 1 according to the present exemplary embodiment, the data d1 “well . . . ” as a surplusage is deleted from the recognition result input data D1 in FIG. 4 obtained as a result of the speech data recognition, “Takanashi-san” in the erroneously recognized data d5 is corrected to “Takahashi-san” and the input data can be registered in each item 12 in the database 10.

As described above, with the input supporting system 1 according to the present exemplary embodiment of the present invention, data can be properly, precisely and efficiently input via speech recognition.

With this structure, since the input candidates can be presented from the data previously accumulated in the database 10 on the basis of the speech recognition result caused by an erroneous speech recognition result, improper data due to a data error, an irrelevant speech or a slip can be eliminated. Since data can be accumulated in a unified expression, the data is easy to view and the data is easy to analyze and use. A data correcting work can be remarkably reduced during input, thereby enhancing a working efficiency.

Since the data extracted from the database 10 is presented to the user, a proper expression can be presented to the user. Thus, since the user can visually learn which expression is more suitable, the user speaks in a more suitable unified expression, thereby enhancing accuracy of data input.

### Second Exemplary Embodiment

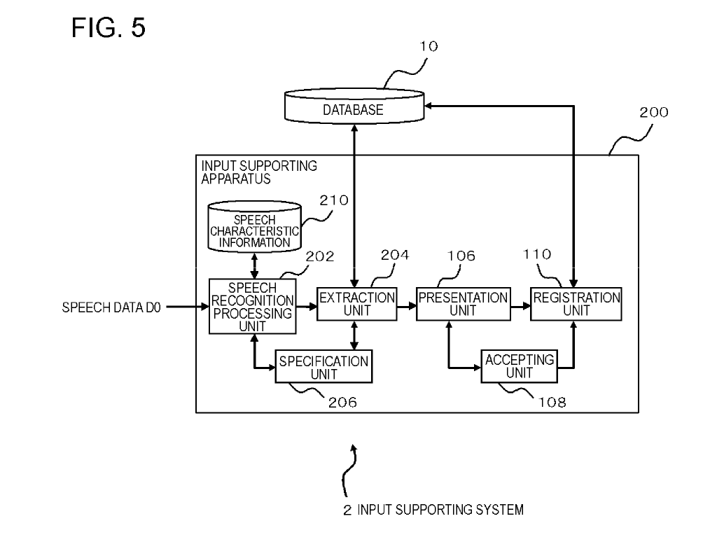

FIG. 5 is a functional block diagram showing a structure of an input supporting system 2 according to an exemplary embodiment of the present invention.

The input supporting system 2 according to the present exemplary embodiment is different from the above exemplary embodiment in that it specifies which item in the database 10 input data corresponds to.

The input supporting system 2 according to the present exemplary embodiment further includes a speech recognition processing unit 202 which performs a speech recognition process on speech data, and a specification unit 206 which specifies parts corresponding to respective items from among the input data which is obtained by the speech recognition process on the speech data by the speech recognition processing unit 202 on the basis of pieces of speech characteristic information on the respective data corresponding to a plurality of items, in addition to the constituents of the above exemplary embodiment, and the extraction unit 204 refers to the database 10, compares each specified part of the input data with the data in the database 10 for the item corresponding to each part, and extracts data similar to each part of the input data from the corresponding item in the database 10.

In the input supporting system 2 according to the present exemplary embodiment, the presentation unit 106 presents, as said candidates, the data extracted by the extraction unit 204 in associations with the respective items specified by the specification unit 206.

Specifically, as illustrated, the input supporting system 2 according to the present exemplary embodiment includes an input supporting apparatus 200 in place of the input supporting apparatus 100 in the input supporting system 1 according to the above exemplary embodiment in FIG. 1. The input supporting apparatus 200 further includes the speech recognition processing unit 202, the extraction unit 204, the specification unit 206 and a speech characteristic information storage unit (indicated as “speech characteristic information” in the drawing) 210 in addition to the presentation unit 106, the accepting unit 108 and the registration unit 110 having the similar structures as in the input supporting apparatus 100 according to the above exemplary embodiment in FIG. 1.

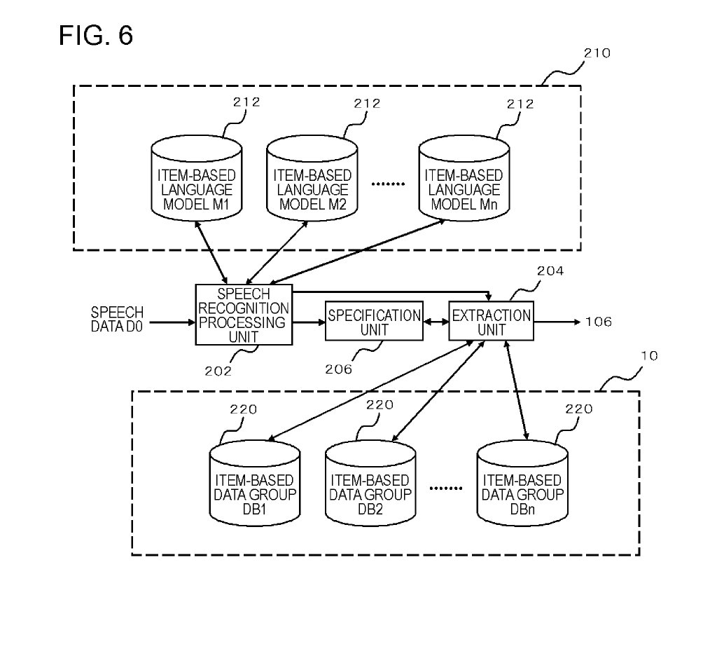

The speech characteristic information storage unit 210 stores speech characteristic information on the data for a plurality of items. In this exemplary embodiment, the speech characteristic information storage unit 210 includes a plurality of item-based language models 212 (M1, M2, . . . , Mn) (here, n is a natural number) as shown in FIG. 6, for example. That is, a language model suitable for each item is provided. The language model herein defines a word dictionary for speech recognition and a probability of connections between respective words contained in this dictionary. Each item-based language model 212 of the speech characteristic information storage unit 210 may be constructed on the basis of data on each item accumulated in the speech characteristic information storage unit 210 so as to be dedicated to each item. The speech characteristic information storage unit 210 may not be included in the input supporting apparatus 200 and may be included in other storing device or the database 10.

In this exemplary embodiment, the speech recognition processing unit 202 may perform the speech recognition processes on the speech data D0 by respectively using item-based language models 212. The speech recognition processing unit 202 uses the item-based language models 212 suitable for respective items to perform the speech recognition processes, thereby enhancing recognition accuracy.

The specification unit 206 adopts, for every parts of the input data which are obtained as results of recognitions by respectively using item-based language models 212 in the speech recognition processing unit 202, parts each of which obtains high recognition result from among said results of the speech recognition processes on the basis of scores such as probabilities of recognitions, and specifies an item corresponding to the item-based language model 212 used in the speech recognition process for each of the adopted parts of data as the item of each of the parts of data.

Further, the speech characteristic information storage unit 210 may include an utterance expression information storage unit (not shown) which stores multiple pieces of utterance expression information associated with each of the plural items. Specifically, for example, the utterance expression information storage unit in the speech characteristic information storage unit 210 stores pieces of the speech data corresponding to the items and the speech recognition results of the speech data in an associated manner.

In this case, the specification unit 206 extracts an expression part similar to the utterance expression associated with the items from the speech data D0 on the basis of the speech recognition result by the speech recognition processing unit 202, the speech data D0 and the utterance expression information, and specifies the extracted expression parts as data on each of the associated item. That is, the specification unit 206 refers to the utterance expression information storage unit, and extracts a part similar to the utterance expression stored in the utterance expression information storage unit from among a series of speech data D0 and the speech recognition result, thereby specifying a part of the data corresponding to each item.

As shown in FIG. 6, the database 10 in this exemplary embodiment includes a plurality of item-based data groups 220 (DB1, DB2, . . . , DBn) (here, n is a natural number).

The extraction unit 204 refers to the database 10 to compare each part of the specified input data with the data in the item-based data group 220 for the item corresponding to each part, and extracts data similar to each part of the input data. In this exemplary embodiment, the data in the item-based data group 220 including the data previously classified into respective items in the database 10 is searched to extract similar data, so that a search processing efficiency is excellent, a processing speed is faster, and accuracy of extracted data increases in comparison with the above exemplary embodiment in which all the data in the database 10 is searched.

In this exemplary embodiment, the presentation unit 106 may display the candidates of item-based data extracted by the extraction unit 204 at predetermined positions of the items necessary for the daily report according to a format previously registered in the storage unit (not shown) as a report format. The input supporting system 2 according to the present exemplary embodiment may register various formats in the storage unit. The reports may be printed by a printer (not shown).

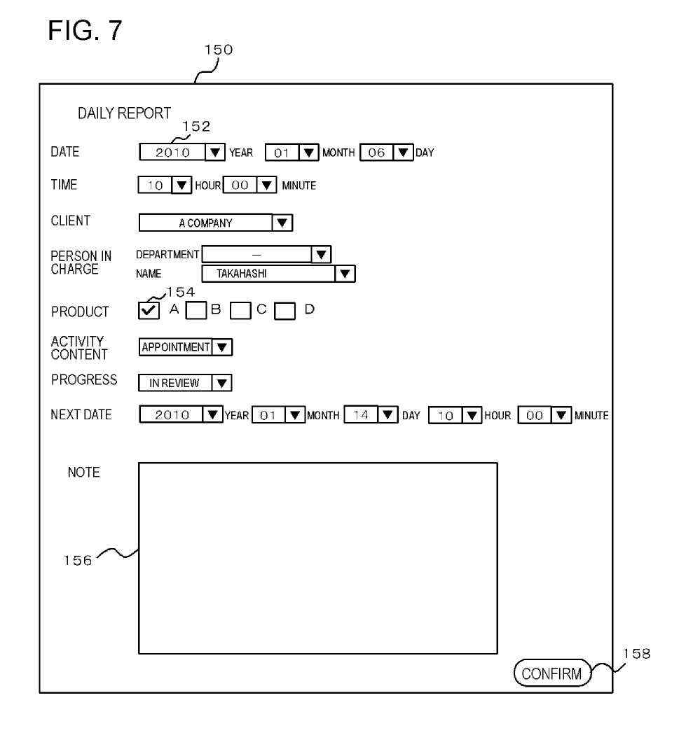

FIG. 7 shows an exemplary daily report screen 150 of business activities displayed on the presentation unit 106. As illustrated, the candidates of each data extracted by the extraction unit 204 are displayed on the daily report screen 150. For example, the data such as date, time, client name and client's person in charge for a business activity is displayed in a pull-down menu 152. Further, target products are displayed in check boxes 154. Other information such as speech recognition result may be all displayed in a text box 156 as a note column, or only the recognition result not corresponding to each item may be displayed. The presentation unit 106 may display the daily report screen 150 on a display unit (not shown) in another user's terminal which is different from the input supporting apparatus 200 and is connected to the input supporting apparatus 200 through a network.

While confirming the contents on the daily report screen 150 in FIG. 7, the user may re-select the data in the pull-down menu 152 or in the check boxes 154, and may correct and add the contents of the text box 156 as needed.

Turning to FIG. 5, the registration unit 110 registers the data accepted by the accepting unit 108 in the corresponding items in the database 10, respectively. For example, a confirmation button 158 in the daily report screen 150 of FIG. 7 is operated to proceed to a screen (now shown) for confirming the final input data, and the user confirms the contents and then presses a registration button (not shown) for registration by the registration unit 110, thereby performing a registration processing.

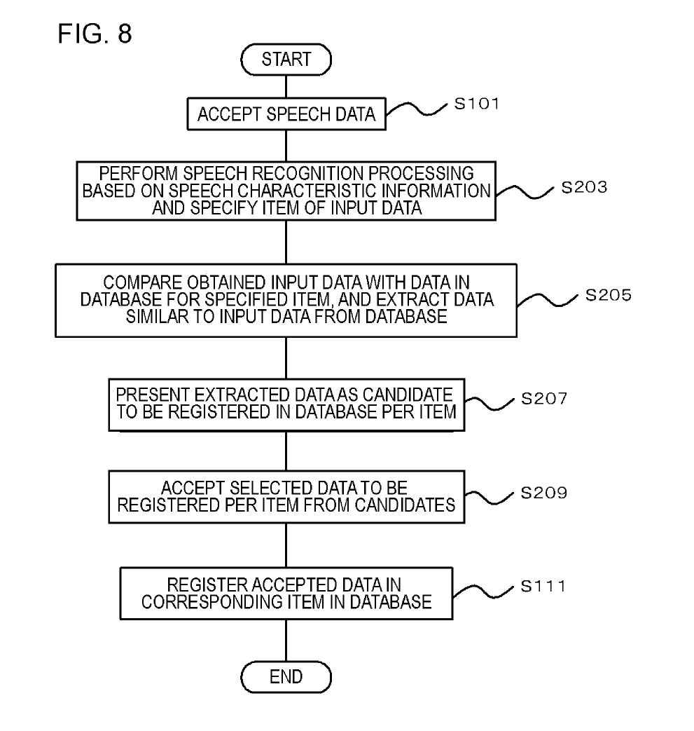

The operations of the input supporting system 2 according to the present exemplary embodiment having the structure will be described below. FIG. 8 is a flowchart showing exemplary operations of the input supporting system 2 according to the present exemplary embodiment. An explanation will be made below with reference to FIGS. 5 to 8. The flowchart of FIG. 8 includes step S101 and step S111 similar as those in the flowchart of the above exemplary embodiment of FIG. 3, and further includes steps S203 to S209.

The speech recognition processing unit 202 in the input supporting apparatus 200 in FIG. 5 accepts speech data of speech which has been uttered by the user and recorded for report creation (step S101 in FIG. 8). The speech recognition processing unit 202 uses respective item-based language models 212 to perform the speech recognition processes on the speech data D0, and the specification unit 206 adopts parts each of which obtains high recognition result on the basis of scores such as probabilities of recognitions from among the results obtained by recognizing respective parts of the speech data by use of respective item-based language models 212 by the speech recognition processing unit 202, and specifies an item corresponding to the item-based language model 212 used in the speech recognition process for each of the adopted parts of data as the item of each of the part of data (step S203 in FIG. 8).

The extraction unit 204 compares each part of the input data obtained from the speech recognition processing unit 202 with the data for the item specified by the specification unit 206 in the database 10, and extracts data similar to each part of the input data from the specified data in the database 10 (step S205 in FIG. 8). Then, the presentation unit 106 displays on the display unit and presents to the user, the daily report screen 150 of FIG. 7 or the like with the data on each item extracted in step S205 in FIG. 8 as candidates to be registered in each item in the database 10 (step S207 in FIG. 8).

The accepting unit 108 accepts selected data to be registered per item from the candidates (step S209 in FIG. 8). The registration unit 110 registers the accepted data in the corresponding item in the database 10 (step S111 in FIG. 8). For example, as shown in FIG. 2, the data is registered in each item of a new record (ID0003) in the database 10.

As described above, the input supporting system 2 according to the exemplary embodiment of the present invention can also obtain similar effects to those in the above exemplary embodiment, and can further extract a part corresponding to each item from a series of speech data on the basis of the speech characteristic information per item, and can specify an item. Therefore, the input data can be presented in association with each item and can be selected by the user, thereby enhancing input accuracy. Since the user can select the relevant data from the data classified into respective items, the input operation is facilitated. The item-based language models 212 are provided so that speech recognition accuracy can be enhanced and recognition errors can be reduced. When a predetermined condition is met, the input data may be automatically registered in the item.

A template such as the daily report screen 150 of FIG. 7 can be presented to the user, and thus is easy to view. Further, proper expressions can be presented to the user in a template. Thus, the user can visually learn which expression is more suitable, and thus speaks in a more suitable unified expression, thereby enhancing input accuracy.

The exemplary embodiments according to the present invention have been described above with reference to the drawings, but are only exemplary for the present invention and various structures other than the above maybe employed.

For example, the input supporting system 2 according to the above exemplary embodiment may further include an automatic registration unit (not shown) which associates data on candidates to items specified by the specification unit 206, selects one piece of data from the candidates under a predetermined condition, and automatically registers it in the database 10.

With the structure, it is efficient that data can be automatically associated with each item and registered. Particularly, since the user can properly express his/her speech, when accuracy of the speech recognition result is also enhanced, a reliability of the automatically registered data is enhanced. The selection conditions include a condition under which a higher similarity with the speech recognition result is preferentially selected, a condition under which a probability of the speech recognition result is higher than a predetermined value and a similarity is equal to or more than a predetermined level, a priority order previously set by the user, and the like.

The input supporting system 1 (or the input supporting system 2) according to the exemplary embodiment may include a generation unit (not shown) which generates new candidates of the input data for the items on the basis of the input data obtained as a result of the speech recognition process on the speech data and the data similar to the input data extracted by the extraction unit 104 (or the extraction unit 204) . With the structure, the presentation unit 106 may present the candidates generated by the generation unit as data for the items.

With the structure, for example, new data may be generated as candidates on the basis of the input data and the data accumulated in the database 10, and may be presented to the user. For example, when the user speaks “today”, a result recognized as “today” may be changed to the recording date “Jan. 10, 2010” as a new candidate of input data on the report date on the basis of the data for the item “date” registered in the database 10 such as information on the recording date of the speech data, and may be generated as a candidate of the input data.

Alternatively, when the speech data such as “Tomorrow I will visit there again.” is input, and when the date of the report or the time stamp of the speech data file is “Jan. 11, 2010”, “Jan. 12, 2010” may be generated as a new candidate of input data corresponding to “Tomorrow”.

The user may transmit the position information on a visited company to the input supporting apparatus 100 (or the input supporting apparatus 200) together with the speech data by use of the GPS function of the user terminal, for example. The generation unit may cause the extraction unit 104 (or the extraction unit 204) to search client information registered in the database 10 on the basis of the position information, to specify a visited client on the basis of the obtained information and to generate a candidate of information on the visited client.

In the input supporting system, the generation unit may perform an annotation processing on the input data obtained as a result of the speech recognition process on the speech data, and may give tag information thereto and generate a new item candidate.

With the structure, title, category, remark and the like maybe newly given as the tag information for the speech data, thereby further enhancing an input efficiency.

The input supporting system may further include a difference extraction unit (not shown) which accepts in time-series a plurality of the speech data which are associated with each other and extracts parts each having a difference between the speech data. The extraction unit 104 or the extraction unit 204 may compare, with the data accumulated in the database 10, input data which is obtained by processing the speech recognition on the part of the difference extracted by the difference extraction unit, and extracts data similar to the difference in the input data from the database 10.

With the structure, the associated speech data are arranged in time-series and a difference therebetween is found so that only a part having the difference can be registered in the database 10. Since only a changed part in the speech data for the relevant matter is registered in the database 10, needless data can be prevented from being registered in an overlapped manner. Thereby, the storage capacity of the database 10 can be remarkably reduced. There may be configured to omit and not to present the confirmation of the presented data on items other than corresponding to the difference or to notify the user of no requirement for confirmation. A load of the registration processing can be reduced and the processing speed can be increased.

The presentation unit 106 according to the above exemplary embodiments may present the data on the items indicating success-fail of the business result to the user by use of symbols such as a round mark “o” for success and a cross mark “x” for fail to discriminate between success and fail, or by use of the visually effective expression manners of color coding, highlighting, or blinking. With the structure, the user may discriminate and recognize at one view, and thus visibility is enhanced and erroneous selection may be prevented. The user may more easily view the created report.

The input supporting system according to the above exemplary embodiment may further include a lack extraction unit (not shown) which extracts items which cannot be obtained from the speech data among the items necessary for the report or the like as data-lacking items, and a notification unit (not shown) which notifies the extracted lacking data to the user. The presentation unit 106 may present candidates of the extracted data-lacking items and promote the user to select data. With the structure, necessary information may be input completely in proper expressions, and thus the data accumulated in the database 10 becomes more useful.

The input supporting system according to the above exemplary embodiment may include an update unit which accepts a user's correction instruction for the candidates of the item data presented by the presentation unit 106 and further performs an update processing via registration or rewrite for the corresponding item data in the database 10. Further, the input data obtained as a result of the speech recognition process may be presented to the user by the presentation unit 106. There may be provided an item edition unit which accepts a user's instruction of extracting part of the presented input data and assuming it as new item data, creates a new item in the database 10, and registers part of the extracted data. Further, the item edition unit may accept an instruction of deleting the existing item or modifying the item, and may delete or modify the items in the database 10.

With the structure, the existing data in the database 10 can be updated or the items may be newly added, deleted and modified.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

When information on the user is obtained and utilized in the present invention, the obtaining and the utilizing are to be lawfully performed.

The present application claims the priority based on Japanese patent application NO. 2010-018848 filed on Jan. 29, 2010, the disclosure of which is all incorporated herein.

1. An input supporting system comprising:
a database which accumulates data for a plurality of items therein;
an extraction unit which compares, with said data accumulated in said database, input data which is obtained as a result of a speech recognition process on speech data and extracts data similar to said input data from said database; and
a presentation unit which presents the extracted data as candidates to be registered in said database.

2. The input supporting system according to claim 1, further comprising:
an accepting unit which accepts selections of data to be registered for said respective items from said candidates presented by said presentation unit; and
a registration unit which registers pieces of the accepted data in the respectively corresponding items in said database.

3. The input supporting system according to claim 1, further comprising:
a speech recognition unit which performs a speech recognition process on said speech data; and
a specification unit which specifies parts corresponding to respective items from said input data which is obtained by the speech recognition process on said speech data in said speech recognition unit on the basis of pieces of speech characteristic information on said respective data corresponding to a plurality of said items,
wherein said extraction unit refers to said database, compares each specified part of said input data with said data in said database for said item corresponding to said each part, and extracts data similar to said each part of said input data from the corresponding item in said database.

4. The input supporting system according to claim 3, wherein said presentation unit presents, as said candidates, said data extracted by said extraction unit in association with said respective items respectively corresponding to said parts specified by said specification unit.

5. The input supporting system according to claim 3, further comprising:
an automatic registration unit which associates said candidates to each of said items respectively corresponding to said parts specified by said specification unit, selects one piece of data from said candidates under a predetermined condition, and automatically registers it in said database.

6. The input supporting system according to claim 3, wherein said speech recognition unit performs speech recognition processes on said speech data for every a plurality of said items by respectively using a plurality of language models, and
said specification unit specifies, for every said parts of the input data which are obtained as results of speech recognition processes by respectively using a plurality of said language models performed by said speech recognition unit, an item corresponding to the language model by which high recognition result is obtained from among said results of said speech recognition processes on the basis of probabilities of the recognitions, and specifies said parts of said input data as data on the specified items, respectively.

7. The input supporting system according to claim 3, comprising:
an expression storing device which stores multiple pieces of speech expression information associated with each of said plural items,
wherein when said speech recognition unit performs speech recognition process, said specification unit extracts an expression part similar to the speech expression associated with said items from said speech data on the basis of said speech data and said speech expression information, and specifies the extracted expression parts as data on each of the associated items.

8. The input supporting system according to claim 1, further comprising:
a generation unit which generates a new candidate corresponding to input data for said item on the basis of data similar to said input data which is obtained as the result of a speech recognition process on said speech data, or said input data which is extracted by said extraction unit,
wherein said presentation unit presents said candidate generated by said generation unit as data corresponding to said item.

9. The input supporting system according to claim 8, wherein said generation unit performs an annotation processing on said input data which is obtained as the result of the speech recognition process on said speech data, attaches tag information thereto, and generates it as a new item candidate.

10. The input supporting system according to claim 1, further comprising:
a difference extraction unit which accepts in time-series a plurality of said speech data which are associated with each other and extracts parts each having a difference between said speech data,
wherein said extraction unit compares, with said data accumulated in said database, input data which is obtained by processing the speech recognition on said part of said difference extracted by said difference extraction unit, and extracts data similar to said difference in said input data from said database.

11. A data processing method in an input supporting apparatus comprising a database which accumulates data for a plurality of items therein, comprising:
comparing, with the data accumulated in the database, input data which is obtained as a result of a speech recognition process on speech data, and extracting data similar to said input data from said database; and
presenting the extracted data as candidates to be registered in said database.

12. A computer program product, comprising:
a nontransitory computer readable medium and,
on the computer readable medium, instructions for causing a computer processor to implement an input supporting apparatus;
wherein the input supporting apparatus comprises a database which accumulates data; and
wherein, for a plurality of items in said database, the processor executes:
a procedure of comparing, with said data accumulated in said database, input data which is obtained as a result of a speech recognition process on speech data, and extracting data similar to said input data from said database; and
a procedure of presenting the extracted data as candidates to be registered in said database.

13. An input supporting system comprising:
a database which accumulates data for a plurality of items therein;
extraction means for comparing, with said data accumulated in said database, input data which is obtained as a result of a speech recognition process on speech data and extracting data similar to said input data from said database; and
presentation means for presenting the extracted data as candidates to be registered in said database.
